(19) United States
(12) Patent Application Publication
(10) Pub. No.: US 2017/0032019 A1
(43) Pub. Date: Feb. 2, 2017

(54) System and Method for the Rating of Categorized Content on a Website (URL) through a Device where all Content Originates from a Structured Content Management System

(71) Applicant: Anthony I. Lopez, JR., Dana Point, CA (US)

(72) Inventor: Anthony I. Lopez, JR., Dana Point, CA (US)

(21) Appl. No.: 14/814,168

(22) Filed: Jul. 30, 2015

(51) Int. Cl. G06F 17/30; H04L 29/06; H04L 29/08

(52) U.S. Cl. CPC G06F 17/30598; H04L 67/02; H04L 67/42; G06F 17/30887; G06F 17/30312; G06F 17/30867

(57) ABSTRACT

The present invention includes a system and method for the rating of organized, structured and categorized content on a website (URL) through a device where all content originates from a structured content management system. Content is classified by way of the URL, Supporting URL, Content Detail URL, and Originating URL and Categorically classified. As content is modified in any way (i.e. edited, deleted) in the content management system, the same content displayed and published on the website (URL) is also automatically modified throughout all devices where the website (URL) is rendered. Management of content can be performed instantaneously on any and all devices including but not limited to desktop/laptop, mobile and tablet devices. Users can rate the categorized content which then provides ratings by way of the aggregate of categories within the respective website (URL), the individual categories, and the specific content within each individual category. The system would allow users future retrieval of content stored in the secured content management system whether or not the content's supporting URL or originating URL still exists or has been deleted or modified.

### DEFINITIONS

Prior to describing the present invention, it is useful to provide definitions for some key terms used herein.

Content: broadly interpreted to include, without exclusion, digital resource that is, or could be accessed on the Internet such as image files, audio files, text files, video files, and any combinations and equivalents thereof.

Desired Content: broadly interpreted to include, without exclusion, any specific wanted data on a digital content platform, such as images, audio, text, video, and any combinations and equivalents thereof.

Atomic Content: broadly interpreted as a single element such as an image, text, or video that is not naturally divisible into smaller units.

Composite Content: broadly interpreted as a content type which has many atomic resources within it, for example, a html web page consisting of many script and image files.

Associated Content: broadly interpreted to include, without exclusion, any and all data of interest, desired or not, associated with an element—whether said element is atomic or composite. Most often, an element of content will have associated content within its composite parent content item.

URL (Uniform Resource Locator): broadly interpreted as a character string that constitutes a reference to atomic and/or composite resources on the World Wide Web.

Supporting URL or Source Location: a URL describing the location of an element or atomic content, which makes up composite content.

Originating URL or Source Location: a URL where original content comes from (typically composite).

Content Detail URL: some atomic content that is embedded in a particular instance of composite content will have associated code indicating a URL which provides additional information about said content. This URL is referred to as the content detail URL.

Web Browser (or browser): broadly interpreted as retrieving, presenting, and traversing information resources on the World Wide Web.

Contextual Information: broadly interpreted as data related to content, including but not limited to URL, supporting URL, originating URL, description, links, metrics, index, or identification.

Unstructured Content: broadly interpreted as information that either does not have a pre-defined data model or is not organized in a pre-defined, classified or categorized method.

Content Management System: broadly interpreted as a computer application that allows publishing, editing, modifying, organizing and deleting of content as well as maintenance from a central interface.

Web Master: broadly interpreted as the person who maintains a particular website.

Storage System: broadly interpreted as a place where data is held in a digital form for access by a computer processor.

Device: broadly interpreted as a mechanical or electronic equipment or thing made for a particular purpose including but not limited to desktops/laptops, mobile devices, and tablet devices.

Website: broadly interpreted as a location connected to the Internet that maintains one or more pages on the World Wide Web.

Rating: broadly interpreted as an evaluation, measurement or assessment on something or someone shown by way of statistics, numbers, symbols, etc.

Populating: broadly interpreted as filling or adding data to a website (URL).

Service Entity: broadly interpreted as a business, person, or system that provides a service, product or content useful to a 3^{rd} party consumer or being.

### BACKGROUND OF THE INVENTION

Websites have for decades been used for many purposes such as to provide information, advertise, or engage in e-commerce. Today, websites are vastly the same and only varying in design and information provided. The number of websites accessible over the Internet estimates millions and as the number of websites and web pages increases, users find it more important to have an Internet web presence. Many Internet users are increasingly accessing the Internet using their phone or mobile device than using a traditional device such as a desktop or laptop computer. Ratings and reviews for consumer products and services relative to these websites have become a necessary aspect of the content shared on many of the websites that relate to these goods and services.

The subjective importance of a website presence and the obstacles relative to their creation has encouraged companies to provide template-based websites for users who either can't afford the traditional costs associated with a website or the time to learn how to create their own website.

Website building and publication tools have become increasingly popular for those who might not have the time, skills or funds to hire a web designer or web master. Such tools often provide web page templates that allow users to enter content and select web page layouts, styles, fonts, colors, etc., and then immediately publish the pages to their website. To publish content onto these templates, users typically must find their unstructured non-categorized content on their desktop or scattered across multiple storage devices, which may not be secure. Then they must follow the protocols of the website building and publication tools to correctly update the content. Since content uploaded is typically unstructured, it is time consuming in search and retrieval as it does not have a pre-defined data model or is not organized in any pre-defined classified or categorical manner. It is searching, locating and then retrieving of this unstructured, non-organized, non-categorized content which lends to time delays when a website user wishes to relay new or more information relative to their business quickly onto their Website.

Although the complex nature of websites has evolved, management and content changes on websites still remains restricted as to time because of unstructured non-categorized content search, location, retrieval and typically third party intervention. Hence, change and management of content on a website must typically follow a protocol of search, location and retrieval of unstructured non-categorized content, then must wait for said changes to occur by those who understand website design and code. In addition, website content cannot be changed remotely from some device. The instantaneous in-time change of unstructured non-categorized content or its management through a device is tenuous at best or simply not available to the website user industry today.

In today's worldwide Internet environment, those websites that do interact with the public to illicit some type of rating typically limit content they share about the service entity to a few pictures, name, location and some information as to the services they perform. Typically a website will populate these service and product entities and ask the public for a review or rating which is measured by some incremental system which aggregates to an overall mean or average that the public can see and benefit by. However, the rating is relative to the service or product entity populated in its entirety and not as to specific content aspects of the entity in a departmentalized categorical way. Typically a restaurant is rated overall and not by way of a departmentalization of content that describes, in a categorical method, a more definitive evaluation of the restaurant. An example of this is a restaurant that may have a rating of 4 out of 5 overall, or 80% good, yet questions arise relative to what aspects of the restaurant was rated less than 5 and what aspect a 5. The subjective aspect of these aggregate ratings on the entity as a whole is simply not as empirically fair as the restaurant rated by its individual departmentalized and categorized content parts like food, service, location, price and ambiance. If all relevant aspects of the restaurant was viewed by a consumer in its departmentalized categorical content parts like food or location, then perhaps it is only location sitting apart from the rest that might empirically exhibit an overall rating on its own less than a 5 and hence the overall reason for the 4. This is a better solution and empirical view for both potential consumers and the service or product entity.

Further, there is no system where specific content within departmentalized categories (i.e. food, service, location) can further be rated in their individual capacities. The category Food for the restaurant may have several subcategories of Food which could also be isolated and rated that would further benefit both viewers and the business by providing a very specified evaluation of the exact content that may have a low or high rating. In the example above, the restaurant may have a 4 out of 5 in the Food category however the 4 is predicated on a specific sub-category like Hamburgers as opposed to Chicken where the Chicken rating is 4 affecting the Food category and the overall aggregate score of 5 for the restaurant. The sub-category Chicken may further include 10 photos that may also be rated in their individual capacities, which affect the overall rating of the sub-category Chicken.

The current model in practice today prevents the population of content to a website in a departmentalized structured manner where all content uploaded to the website is content organized in a structured categorical method. As stated, typically desired content to be published to a website must first be located, which is not easily accomplished from conventional storage systems where the retrieval of content follows traditional unstructured, unorganized and non-categorized methodology. When said content is located, it must then be retrieved for third party contractors or the user using website building and/or publication tools to perform the necessary work before said ultimate change in the website occurs. Where one website is populating content that reflects another entity or that entity's website content, content shared by the website from the entity is limited, at best unstructured, or not at all.

Therefore, a solution that would be more practical and desirable for the consumer, and service and product entities would be a system and method that allows users to rate categorized content on respective websites (URLs) through any and all devices, including but not limited to a traditional computing device, mobile device or table device. Said categorical content originating from a secure content management system that helps users convert unstructured content into organized, structured and categorized content for specific search, retrieval and rating of content quickly. Users would have the benefit of organized, departmentalized and categorized content that could also be individually shared and exhibited, and more importantly independently rated by way of the aggregate of categories within the respective website (URL), the individual categories, and the specific content within each individual category. Theoretically, not only would users have a more detailed explanation as to a service and product entity's overall rating but service and product entities would have more empirical consumer view regarding their goods and services, what to analyze, change and modify if necessary. They could then manage and update their URL content immediately and instantaneously utilizing their devices, which interface with their respective content management systems simultaneously rendering all URL content on all devices.

### BRIEF SUMMARY OF THE INVENTION

The present invention includes a system and method for the rating of organized, structured and categorized content on a website (URL) through a device where all content originates from a structured content management system. Content is classified by way of the URL, Supporting URL, Content Detail URL, and Originating URL and Categorically classified. As content is modified in any way (i.e. edited, deleted) in the content management system, the same content displayed and published on the website (URL) is also automatically modified throughout all devices where the website (URL) is rendered. Management of content can be performed instantaneously on any and all devices including but not limited to desktop/laptop, mobile and tablet devices. Users can rate the categorized content which then provides ratings by way of the aggregate of categories within the respective website (URL), the individual categories, and the specific content within each individual category. The system would allow users future retrieval of content stored in the secured content management system whether or not the content's supporting URL or originating URL still exists or has been deleted or modified.

The following description is presented to enable one of ordinary skill in the art to make and use the invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

### BRIEF DESCRIPTION OF THE DRAWINGS

FIG. 1 is a block diagram illustrating an exemplary embodiment of the system and method for the rating of categorized content on a website (URL) through a device where all content originates from a structured content management system according to the present invention;

FIG. 2 is a flowchart illustrating an exemplary embodiment of a method of how the system determines, identifies, and stores specific elements according to the present invention;

FIG. 3 is a flowchart illustrating an exemplary embodiment of a method of how the system determines, stores and categorizes specific elements according to the present invention;

FIG. 4 is a flowchart illustrating an exemplary embodiment of a method of how the system is initialized from a client through the server process to retrieve content according to the present invention;

FIG. 5 is a flowchart illustrating an exemplary embodiment of a method of how the system is initialized from a client through the server process to display content according to the present invention;

FIG. 6 is a flowchart illustrating an exemplary embodiment of a method of how the system is initialized from a client through the server process to make changes to content according to the present invention;

FIG. 7 is a flowchart illustrating an exemplary embodiment of a method of how the system is initialized from a client through the server process to rate content according to the present invention;

FIG. 8 is a flowchart illustrating an exemplary embodiment of a method of how the system displays the aggregate rating of categories, ratings of each individual category, and ratings of specific content within each individual category on a website URL.

### DETAILED DESCRIPTION

It should be appreciated that the present invention can be implemented in numerous ways, including as a process, or apparatus, a system, or a computer readable medium such as a computer readable storage medium or a computer network wherein program instructions are sent over optical or electronic communication links. It should be noted that the order of disclosed processes may be altered within the scope of the invention.

A detailed description of one or more preferred embodiments of the invention is provided below along with accompanying figures that illustrate by way of example the principles of the invention. While the invention is described in connection with the embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

An element according to the present invention encompasses digital content to include but not limited to meta data, text, image files, sound files, and video files. In order for the invention to properly provide and display interactive contextual information and originating URL for content, content is sent through a smart server wherein they are processed to either a database server or media store server where the content is separated into component content parts and associated URL, supporting URL, content detail URL, and originating URL. On the database server textual elements are indexed while on the media store server if applicable, a unique identifier is generated in association with an element that can be anything from an image file or video file. Requests from users are then sent back through the smart server to the user's device where the user can view all content containing the request. If pre-existing content is sent through the system, the system will filter out the duplicate content, replacing it with a unique identifier. In this manner, media is stored and retrieved without duplication, while still allowing varied meta data to be associated with said content.

In an exemplary embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device. The medium can be an electronic, magnetic, optical, electromagnetic, infrared, or semiconductor system (or apparatus of device) or a propagation medium.

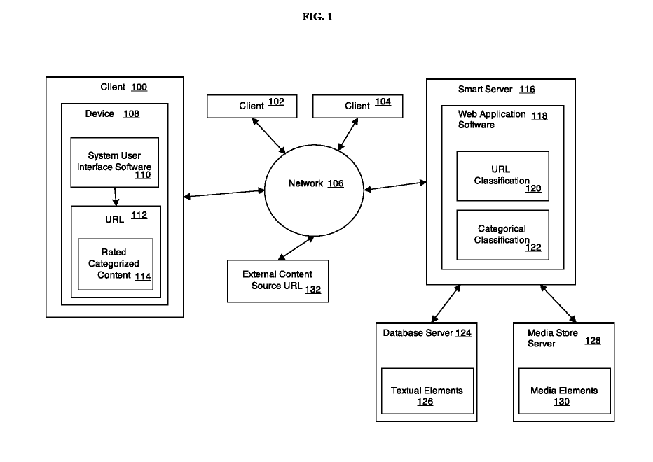

FIG. 1 is a block diagram illustrating an exemplary embodiment of a system displaying multiple hardware and software components of a system for the rating of categorized content on a website (URL) through a device where all content originates from a structured content management system. A client's 100 device 108 interacting with a System User Interface Software 116 which displays content on a URL 112 that has rated categorized content 114, interacts and sends client 100 commands through the network 106 to a Smart Server 116 where Web Application Software 118 executes said commands to determine, classify, store, manage and rate content by way of URL Classification 120 and Categorical Classification 122 from an external content source URL 132. The content is processed either to a Database Server 124 where textual element indexing 126 occurs or to a Media Store Server 128 where media elements 130 are assigned unique identifiers in association with relevant applicable content.

The client 100 can then retrieve the content from the Smart Server 116 through a device 108 where the System User Interface Software 116 requests all the elements or parts of the elements. All separated textual elements 126 from Database Server 124 and media elements with unique identifiers 130 from Media Store Server 128 are now transferred to the client 100 through the Web Application Software 118 from the Smart Server 116 through the network 106 interacting with the System User Interface Software 110 where the client 100 views the content on a device 108. The remainder of the elements may be retrieved at a later stage or not at all, as it is stored in the Smart Server 116.

Other clients, as represented in 102 and 104 running on other system user interface software may also be connected to the network 106. If the content from the URL is changed, moved, deleted or its access restricted, these clients will be unable to utilize said URLs for content retrieval. Whereas client 100 of this invention will be able to retrieve from the Smart Server 116 the archived content independently of its external existence on its originating server. Clients 102 and 104 connected to the network 106 may view client's 100 website URL 112 from his/her own device.

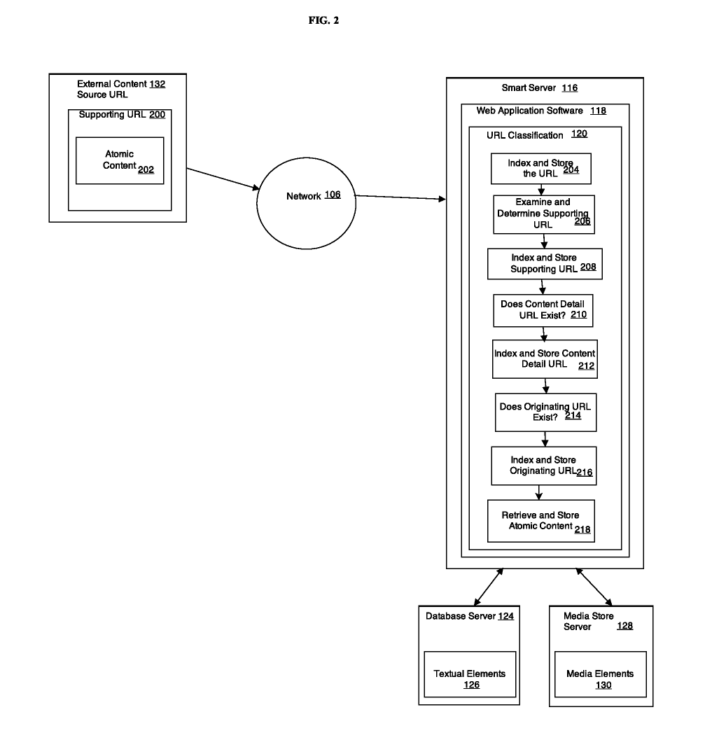

FIG. 2 is a flowchart that further illustrates an exemplary embodiment of a system and method of URL Classification 120 displaying through multiple hardware and software components whereby the atomic content 202 with a supporting URL 200 from an external content source URL 132 is retrieved through the network 106 by the Smart Server 116 where the Web Application Software 118 indexes and stores the URL 204, examines and determines supporting URL 206, indexes and stores supporting URL 208, determines content detail URL 210, indexes and stores content detail URL 212, determines originating URL 214, indexes and stores originating URL 216, and retrieves and stores atomic content 218.

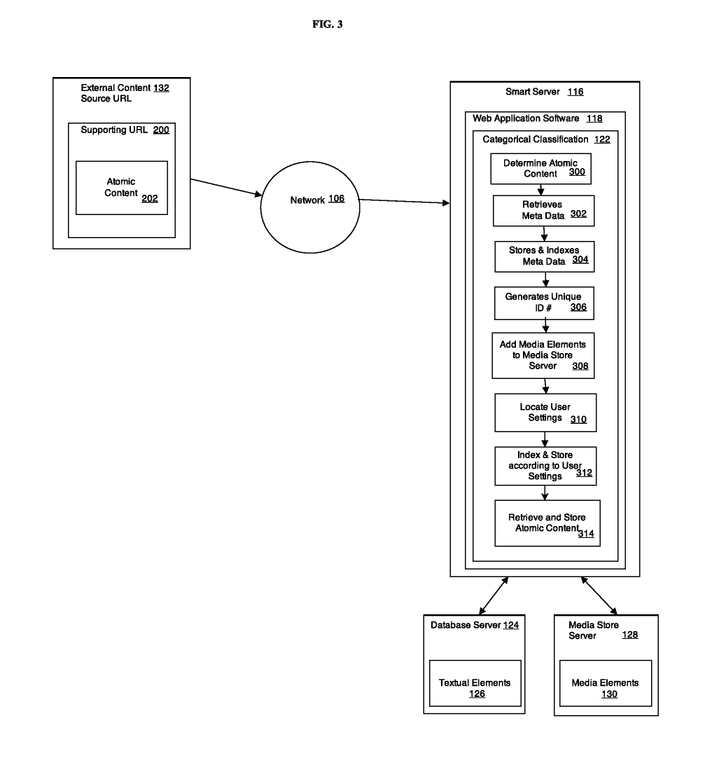

FIG. 3 is a flowchart that further illustrates an exemplary embodiment of a system and method of Categorical Classification 122 displaying through multiple hardware and software components whereby the atomic content 202 with a supporting URL 200 on an external content source URL 132 is retrieved through the network 106 by the Smart Server 116 where the Web Application Software 118 determines atomic content 300, retrieves meta data 302, stores and indexes meta data 304, generates unique id # 306, adds media elements to media store server 308, locates user settings 310, indexes and stores according to user settings 312, retrieves and stores atomic content 314.

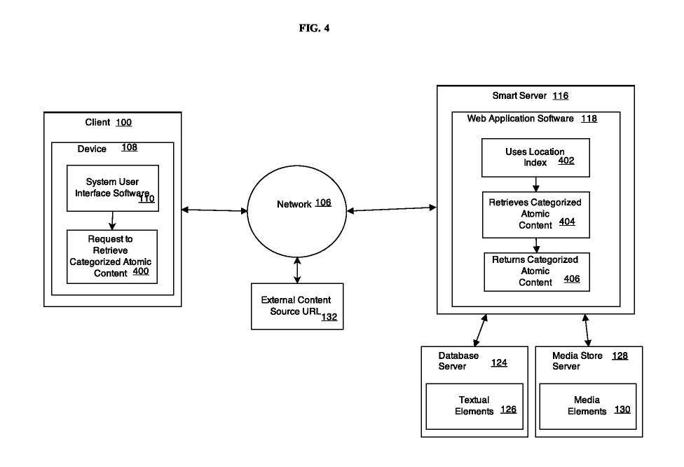

FIG. 4 is a flowchart that further illustrates an exemplary embodiment of a system and method displaying through multiple hardware and software components whereby requests to retrieve categorized atomic content 400 sent from the client 100 interacting with the System User Interface Software 110 through the network 106 are received by the Smart Server 116 where the Web Application Software 118 uses location index 402, retrieves categorized atomic content 404, and returns categorized atomic content 406 to the client 100 through the network 106 interacting with the System User Interface Software 110 where it is viewed on the device 108.

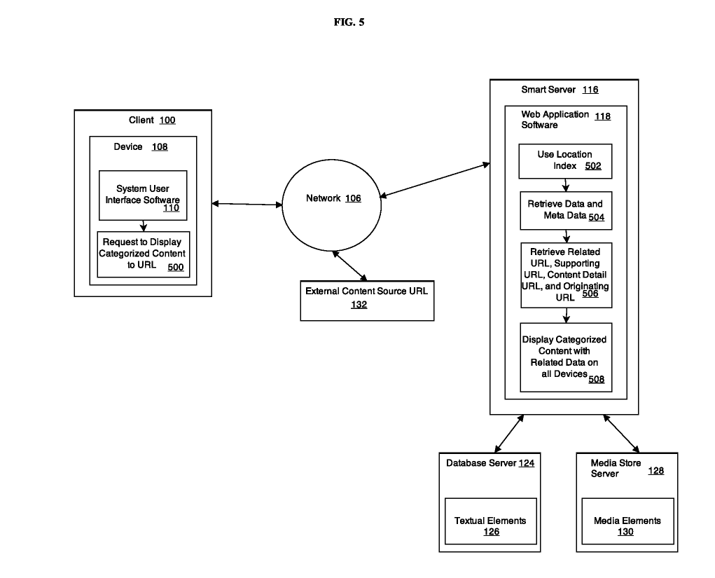

FIG. 5 is a flowchart that further illustrates an exemplary embodiment of a system and method displaying through multiple hardware and software components whereby client 100 requests to display categorized content to URL 500 interacting with the System User Interface Software 110 sent through the network 106 are received by the Smart Server 116 where the Web Application Software 118 uses location index 502, retrieves data and meta data 504, retrieves related URL, supporting URL, content detail URL, and/or originating URL 506, and displays categorized content with related data on all devices 508.

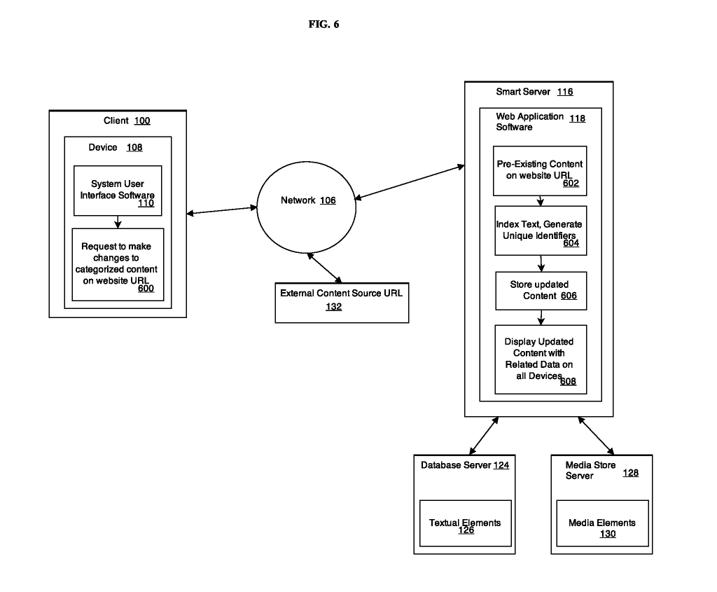

FIG. 6 is a flowchart that further illustrates an exemplary embodiment of a system and method displaying through multiple hardware and software components whereby client 100 requests to make changes to categorized content on website URL 600 interacting with the System User Interface Software 110 sent through the network 106 are received by the Smart Server 116 where the Web Application Software 118 locates pre-existing content on website URL 602, indexes text and generates unique identifiers 604, stores updated content 606, and displays updated content with related data on all devices 608.

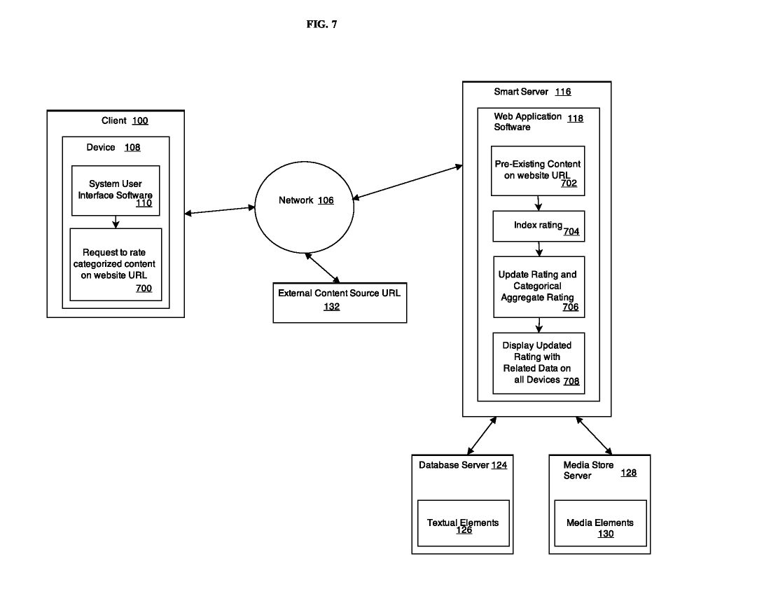

FIG. 7 is a flowchart that further illustrates an exemplary embodiment of a system and method displaying through multiple hardware and software components whereby client 100 requests to rate categorized content on a website URL 700 interacting with the System User Interface Software 110 sent through the network 106 are received by the Smart Server 116 where the Web Application Software 118 locates pre-existing content on a website URL 702, indexes rating 704, updates rating and categorical aggregate rating 706, and displays updated rating with related data on all devices 708.

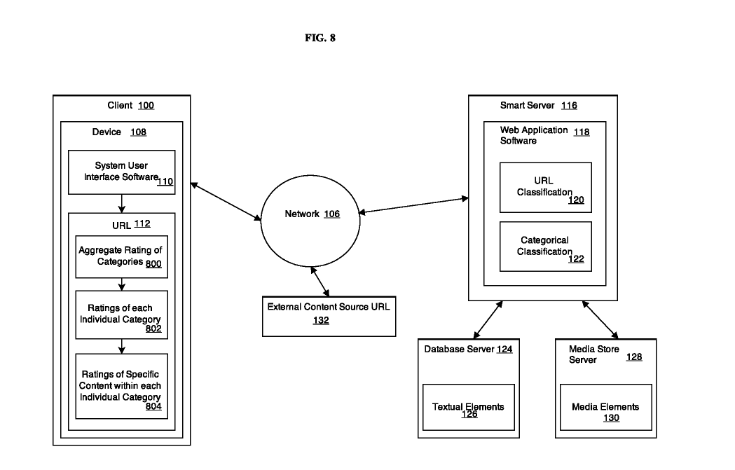

FIG. 8 is a flowchart that further illustrates an exemplary embodiment of a system and method displaying through multiple hardware and software components whereby client 100 through a device 108 using System User Interface Software 110 views the aggregate rating of categories 800, ratings of each individual category 802, and ratings of specific content within each individual category 804 on a website URL 112.

What is claimed is:

1. A method, for the rating of categorized content on a website (URL) through a device where all content originates from a structured content management system, the method comprising: of an operation to be performed on a smart server; perform the following steps on a smart server which further interacts with the appropriate Database Server and Media Store Server to: classify, store, retrieve, manage, and rate content; wherein the client device does not block thereby allowing one or more operations to be performed at the client device; receiving from the smart server the content, its URL, its supporting URL, and/or originating URL.

2. A method as recited in claim 1, the method comprising: of an operation to be performed on a smart server by way of URL Classification; in response to the client request, perform the following steps on a smart server which further interacts with the Database Server and Media Store Server to: index and store the URL, examine and determine supporting URL, index and store supporting URL, determine content detail URL, index and store content detail URL, determine originating URL, index and store originating URL, retrieve and store atomic content.

3. A method as recited in claim 1, the method comprising: of an operation to be performed on a smart server by way of Categorical Classification; in response to the client request, perform the following steps on a smart server which further interacts with the Database Server and Media Store Server to: determine atomic content, retrieve meta data, store and index meta data, generate unique id #, add media elements to media store server, locate user settings, index and store according to user settings, retrieve and store atomic content.

4. A method as recited in claim 1, the method comprising; of an operation to be performed on a smart server; in response to the client request at a client device, perform the following steps on a smart server which further interacts with the Database Server and Media Store Server to: use location index, retrieve categorized atomic content, and return categorized atomic content.

5. A method as recited in claim 1, the method comprising; of an operation to be performed on a smart server; in response to the client request at a client device, perform the following steps on a smart server which further interacts with the Database Server and Media Store Server to: use location index, retrieve data and meta data, retrieve related URL, supporting URL, content detail URL, and/or originating URL, and display categorized content with related data on all devices.

6. A method as recited in claim 1, the method comprising; of an operation to be performed on a smart server; in response to the client request at a client device, perform the following steps on a smart server which further interacts with appropriate database servers and media servers to: locate pre-existing content on website URL, index text and generate unique identifiers, store updated content, and display updated content with related data on all devices.

7. A method as recited in claim 1, the method comprising; of an operation to be performed on a smart server; in response to the client request at a client device, perform the following steps on a smart server which further interacts with appropriate database servers and media servers to: locate pre-existing content on website URL, index rating, update rating and categorical aggregate rating, and display updated rating with related data on all devices.

8. A method as recited in claim 1, the method comprising; of an operation to be performed on a smart server; in response to the client viewing at a client device, perform the following steps on a smart server which further interacts with appropriate database servers and media servers to: view aggregate rating of categories, ratings of each individual category, and ratings of specific content within each individual category on a website URL.

8. A method as recited in claim 1, wherein the client device displays the response via a browser.

9. A method as recited in claim 1, wherein the client device operates on the server data that allows for client side modification of server data received.

10. A method as recited in claim 9, wherein the client device being configured to receive user input that performs a change that requires an operation to be performed on the smart server; respond to the client input by: generating a request for the operation to be performed on the smart server; one or more operations to be performed in response to the request; and sending the response to the client device.

11. A method for a computer readable medium on a client device, the method comprising: receiving user input at a client device that performs a change that requires an operation to be performed on the smart server; in response to the user input, perform the following steps on the client device: generating request for the operation to be performed on the smart server; and sending the request to the smart server; wherein the client device does not block while waiting for the response from the smart server to the request, thereby allowing one or more operations to be performed at the client device after the client device sends the request and before the client device receives the response to the request; receiving the response, processing elements that were generated upon the user input.

12. A method as recited in claim 11, wherein the client device displays the response via a browser.

13. A method as recited in claim 11, wherein the client device operates on the server data that allows for client side modification of server data received.

14. A method as recited in claim 13, wherein the client device being configured to receive user input that performs a change that requires an operation to be performed on the smart server; respond to the client input by: generating a request for the operation to be performed on the smart server; one or more operations to be performed in response to the request; and sending the response to the client device.
